(19) United States
(12) Patent Application Publication
(10) Pub. No.: US 2006/0104003 A1
(43) Pub. Date: May 18, 2006

(54) Protective device for electric power distribution network

(76) Inventor: Boris Gautier, Lourdes (FR)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/523,039

(22) PCT Filed: Aug. 5, 2003
(86) PCT No.: PCT/FR03/02465

§ 371 Date: Oct. 3, 2005

(30) Foreign Application Priority Data
Aug. 5, 2002 (FR) 02/09945

(51) Int. Cl. H02H 9/06

(52) U.S. Cl. 361/120

(57) ABSTRACT

A device for protecting an electrical power distribution network against the overvoltages due to a lightning strike is disclosed herein. The device comprises a first electrode electrically coupled to the electrical power distribution network, a second electrode connected to a grounding conductor, focusing means capable of guiding an electric arc generated between the two electrodes toward a fractionation device, and a casing. The casing accommodates the two electrodes, the focusing means and the fractionation device. The casing is in communication with the outside through at least one discharge channel designed to substantially lower the temperature of the gases generated by the formation of the electric arc, wherein each discharge channel has at least one change of section.

### FIELD OF THE INVENTION

The present invention relates to the general technical field of devices for protecting electrical equipment or installations, such as electrical appliances, circuits or distribution networks, against electrical supply disruption.

The invention relates more particularly to a device for protecting an electrical power distribution network against voltage disruptions, such as overvoltages, in particular due to a lightning strike.

The present invention relates to a device for protecting an electrical power distribution network against the overvoltages due, in particular, to a lightning strike, this protective device comprising a first electrode electrically connected to the network to be protected, a second electrode connected to a grounding conductor, and focusing means capable of guiding an electric arc generated between the two electrodes toward a fractionation device, said device comprising a casing which accommodates the two electrodes, the focusing means and the fractionation device, this casing being in communication with the outside through at least one discharge channel designed so as to substantially lower the temperature of the gases generated by the formation of the electric arc.

### BACKGROUND OF THE INVENTION

Various types of devices have been envisaged for protecting electrical power distribution networks against overvoltages. In particular, when wishing to protect an installation against the effects of a lightning strike in its immediate vicinity, it is already known to place a lightning arrester of the air gap type at the head of this installation.

Such a device has two electrodes, one electrically connected to the phase to be protected, and the other electrically connected to a grounding conductor. These two electrodes are separated by a layer of air or by a gap containing dielectric material. During operation, when a lightning current arrives through the phase conductor to be protected and creates an overvoltage that reaches a predetermined value, breakdown occurs in the layer of air or along the dielectric material, and an electric arc is established between the two electrodes. The short circuit formed in this way allows the lightning current to flow away to ground.

The advantage of this type of lightning arrester is that it makes it possible to discharge very heavy lightning currents, of the order of several tens of kiloamperes. Such a device, however, also has two major drawbacks.

The first resides in the fact that discharging the current through an electric arc causes significant release of hot gases, or even flames, which may damage the immediate environment of the device.

The second resides in the fact that the electric arc which is generated causes a short circuit between the phase and ground, and that this electric arc is not quenched spontaneously after the lightning current has passed. A current, referred to as a follow current, then continues to flow to ground and may cause the installation to become inoperative.

In order to overcome the first drawback, it has been proposed, particularly in document DE-196 04 947, for the two electrodes to be encapsulated in a casing which is leaktight, so as to prevent the expulsion of any dangerous material. Such devices, however, do not make it possible to cut off the follow current efficiently because their capacity does no exceed a few kiloamperes, since it is generally of the order of one kiloampere.

In order to overcome the second drawback, it has already been proposed, particularly in documents DE-44 35 968 and DE-44 39 730, for a fractionation device, produced in the form of a set of parallel metal plates, to be placed in the vicinity of the electrodes. Focusing means are also provided in order to guide the electric arc toward this set of plates, in which it will be fractionated and cooled, which will lead to its quenching and therefore to cutoff of the follow current. Such protective devices, however, are not encapsulated and entail significant release of flames during their operation.

A device provided with a chamber for cooling the gases produced by the electric arc is furthermore known, from document EP-869 118, said chamber being equipped with internal partitions intended to extend the residence time of the gas in the chamber. The arrangement proposed in this document, however, has the drawback of being particularly bulky, especially in terms of the thickness of the lightning arrester, which is oversized compared with that of conventional devices owing to the presence of the chamber. This extra thickness is therefore liable to impair connection of the lightning arrester to a conventional standardized electrical fuse panel.

### SUMMARY OF THE INVENTION

The objects of the invention are consequently to provide a way of overcoming the various drawbacks listed above, and to provide a novel device for protecting an electrical power distribution network against overvoltages, which allows excellent cooling of the hot gases generated during operation while being designed in a particularly simple and reliable way.

It is also an object of the invention to provide a novel device for protecting an electrical power distribution network against overvoltages, which is of a particularly compact type and can be connected to standard installations.

It is also an object of the invention to provide a device for protecting an electrical power distribution network against overvoltages, the safety level of which is enhanced.

It is also an object of the invention to provide a device for protecting an electrical power distribution network against overvoltages, which is particularly simple and inexpensive to construct.

The objects of the invention are achieved with the aid of a device for protecting an electrical power distribution network against the overvoltages due, in particular, to a lightning strike, this protective device comprising a first electrode electrically connected to the network to be protected, a second electrode connected to a grounding conductor, and focusing means capable of guiding an electric arc generated between the two electrodes toward a fractionation device, said device comprising a casing which accommodates the two electrodes, the focusing means and the fractionation device, this casing being in communication with the outside through at least one discharge channel designed so as to substantially lower the temperature of the gases generated by the formation of the electric arc, characterized in that said at least one discharge channel has at least one change of section.

### BRIEF DESCRIPTION OF THE DRAWINGS

Other features and advantages of the invention will be understood more clearly from the following description and the appended drawings, given purely by way of illustration and without implying any limitation, in which:

FIG. 1 is a view in cross section of a protective device according to the present invention.

FIG. 2 is a view in section on the line II-II of the protective device represented in FIG. 1.

FIG. 3 is a view in cross section of another protective device according to the invention.

### DESCRIPTION OF PREFERRED EMBODIMENTS

The present invention relates to a device 1, 101 for protecting an electrical power distribution network against the overvoltages due, in particular, to a lightning strike, this protective device comprising a first electrode 3 electrically connected to the network to be protected, a second electrode 4 connected to a grounding conductor, and focusing means 5 capable of guiding an electric arc generated between the two electrodes toward a fractionation device 6. Said device comprises a casing 2, 102 which accommodates the two electrodes 3, 4, the focusing means 5 and the fractionation device 6, this casing 2, 102 being in communication with the outside through at least one discharge channel 7, 107 designed so as to present internal obstacles against releases of fluid and residues generated by the formation of the electric arc between the two electrodes.

Each of these discharge channels 7, 107 thus forms a conduit which makes it possible, on the one hand, to retain any particles of incandescent materials inside the casing 2 and, on the other hand, to lower the pressure and therefore the temperature of the gases generated by the formation of the electric arc. The installations are furthermore protected from the follow current because such a protective device comprises a fractionation device 6.

The internal obstacles, which each of the discharge channels 7, 107 has, are advantageously formed by at least one chicane 20, 120, which may form an angle of between 45° and 180° and/or by at least one change of section.

The term “chicane” here means a device which modifies the direction of the route of the gases, in order to ensure their relaxation. A chicane forming an angle of 90° thus corresponds to a bend substantially equal to a right angle, while a chicane forming an angle of 180° will cause a U-turn of the gases.

In the scope of the invention, the chicanes could advantageously be formed by the arrangement of the channels 7, 107 themselves, by making these follow a winding path.

The term “change of section” here means a variation in the cross section of the channel itself, which is obtained by modifying the dimensions of the conduit forming the channel.

Advantageously, said at least one channel 7, 107 extends substantially in the same plane is the fractionation device 6.

In other words, the symmetry axis of the fractionation device 6 and the symmetry axis of said at least one discharge channel 7, 107 are substantially coplanar.

This arrangement makes it possible to obtain a protective device, the thickness E of which is governed substantially not by the gas discharge components 7, 107, but only by the “active” components such as the electrodes, the focusing device and the fractionation device.

The fractionation device 6 is preferably arranged between the focusing means 5 and the inlet of each of the discharge channels 7, 107.

Also preferably, the fractionation device 6 is formed with the aid of a set of parallel metal plates 14. These may then be kept at a distance from one another with the aid of two blades 15 having orifices engaged in lateral lugs 16 located on each of the metal plates 14.

The focusing means 5 advantageously define an inverted pyramidal space 10 between the electrodes 3, 4 and the fractionation device 6.

In other words, the focusing means 5 define an arc guiding space substantially having an overall shape which diverges in the direction of the fractionation device. This divergent V shape makes it possible to guide the arc and convey it to the fractionation device 5.

The casing 2 is preferably made of a dielectric material, such as a thermosetting or thermoplastic material, for instance polycarbonate.

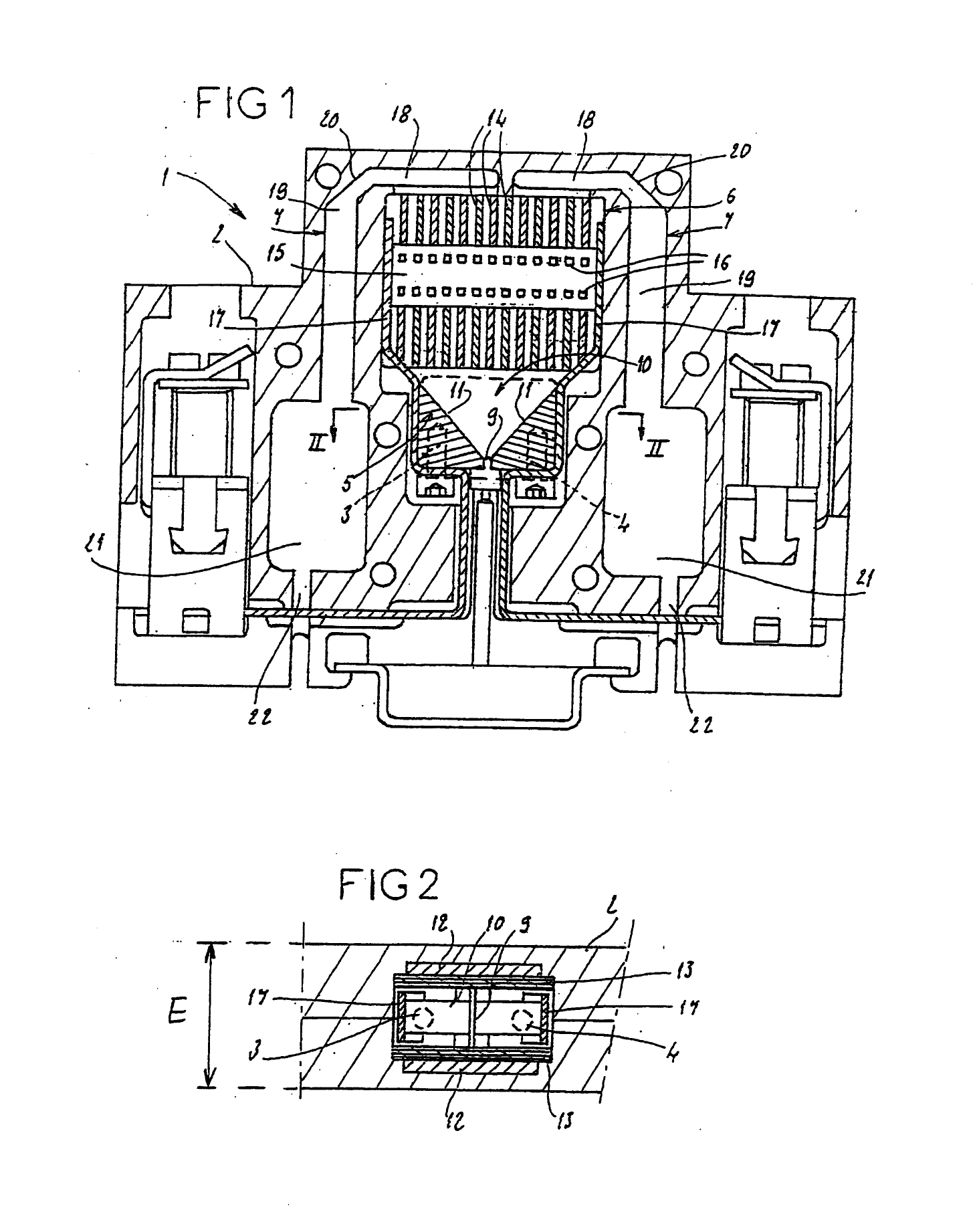

The alternative embodiment corresponding to FIGS. 1 and 2 will now be described in more detail.

A protective device 1 according to the invention, as represented in FIGS. 1 and 2, consists of a casing 2 made of a dielectric material, such as a thermosetting or thermoplastic material, for instance polycarbonate. This casing 2 contains, in particular, two electrodes 3, 4, focusing means 5, a fractionation device 6 and two discharge channels 7.

More precisely, a dielectric part 9 is positioned between the electrodes 3, 4, which are accommodated in an inverted pyramidal space 10 delimited by the focusing means 5. The latter are formed with the aid, on the one hand, of two conductive parts 11 inclined in a “V” shape and converging at their lower ends toward the dielectric part 9 and, on the other hand, two vertical conductive plates 12 facing each other on either side of the dielectric part 9. An insulating plate 13 is advantageously interposed between the conductive parts 11 and the conductive plates 12.

The conductive parts 11 are extended by parallel parts 17; the fractionation device 6 is fixed in the casing 2 while overhanging the upper ends of the parts 11, between the parts 17. This fractionation device 6 is formed with the aid of a set of parallel vertical metal plates 14 kept at a distance from one another by two blades 15, which are located on either side of the metal plates 14 and have orifices engaged in lateral lugs 16 located on each of the metal plates 14. These plates 14 are substantially parallel to the parts 17; the distance between the end plates 14 and the corresponding parts 17 is substantially identical to the gap separating the plates 14. One of the electrodes 3, 4 is connected to the electrical power distribution network to be protected, and the other is connected to a grounding electrode.

The two discharge channels 7 correspond to recesses provided inside the casing 2, and are symmetrical with respect to a vertical plane passing through the dielectric part 9. They each have a horizontal first portion 18 of small cross section, located overhanging the upper ends of the plates 14, at the outlet of the fractionation device 6. This first portion 18 merges into a vertical second portion 19 with a widened cross section, after having passed through a chicane 20 forming an angle of about 90°. The second portion 19 opens into a vertical third portion 21 with an even larger cross section, having an axis of revolution offset toward the edge of the casing 2 compared with that of the second portion 19. Lastly, this third portion 21 opens into a vertical fourth portion 22 of small cross section which, on the one hand, is in free communication with the outside of the casing 2 and, on the other hand, has an axis of revolution offset toward the edge of the casing 2 compared with that of the third portion 21.

During operation, for example when a lightening current arrives through the conductor of the network to be protected and creates an overvoltage that reaches a predetermined value, an electric arc is established between the two electrodes 3, 4. This electric arc is then guided toward the fractionation device 6 with the aid of the focusing means 5, so as to cut off the follow current. Possible releases of fluid and residue, generated by the formation of the electric arc, are furthermore retained in the casing 2 with the aid of the chicane 20 and the changes of section between the various portions 18, 19, 21, 22 constituting the obstacles internal to the discharge channels 7. In the end, this protective device 1 will release neither incandescent material nor burning gas into its immediate environment. It may therefore be installed in the majority of applications.

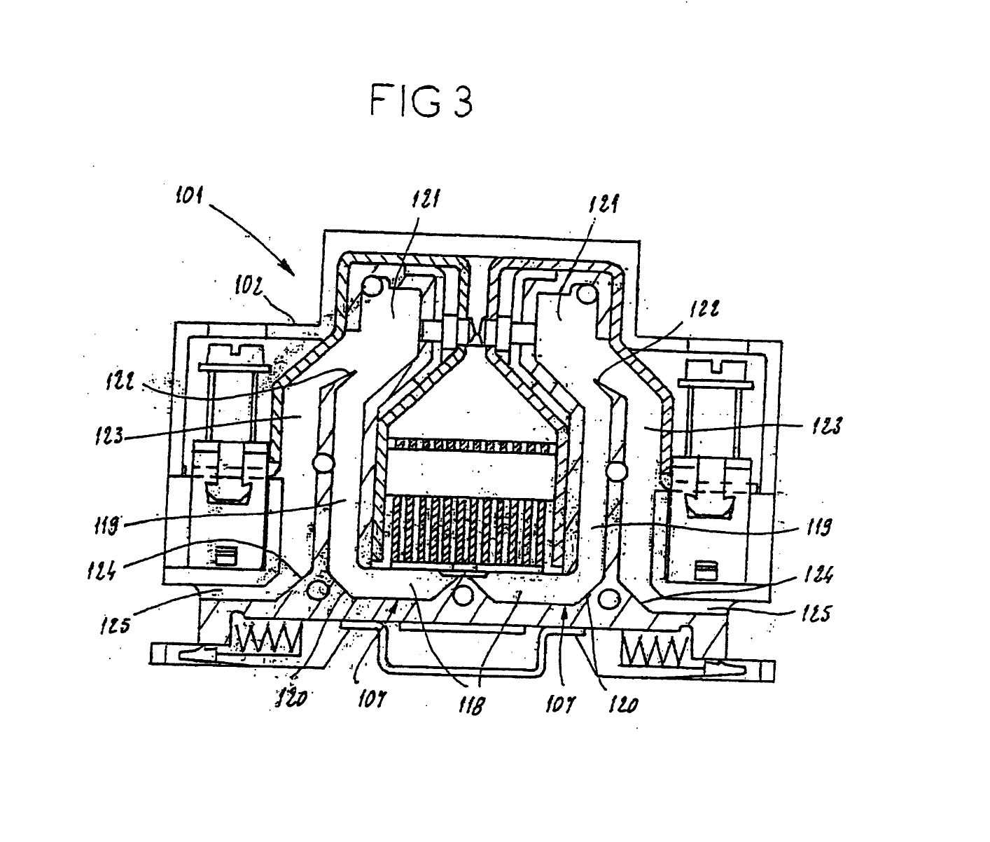

Another variant of the protective device 101 according to the invention is represented in FIG. 3, and differs principally from the protective device 1 in that it is provided with a casing 102 having two discharge channels 107 with a more complex shape. Each discharge channel 107 is extended laterally relative to the fractionation device, and is formed from a horizontal first portion 118 which originates at the outlet of the fractionation device and merges, as explained above, into a descending vertical second portion 119 after having passed through a first chicane 120 forming an angle of about 90°. The second portion 119 runs along the fractionation device and ends in a second chicane 122 forming an angle of about 45°, and opens into a lower cavity oriented toward the center of the casing 102. This cavity 121 is also connected to an ascending vertical third portion 123 extending parallel to the first portion 119, said second portion having a length substantially equal or similar to that of said first portion 119. After having passed through a third chicane 124 forming an angle of about 90°, said second portion 123 opens into a horizontal fourth portion 125 with a reduced cross section, which is in free communication with the outside of the casing 102.

Chamfers may be provided at each of the chicanes 120, 124 so as to modify the cross section of the channel 107, by reducing it.

The overall operation of the protective device 101 remains similar to that described above.

The invention also independently relates to a device 1, 101 for protecting an electrical power distribution network against the overvoltages due, in particular, to a lightning strike, this protective device comprising a first electrode 3 electrically connected to the network to be protected, a second electrode 4 connected to a grounding conductor, and focusing means 5 capable of guiding an electric arc generated between the two electrodes toward a fractionation device 6, said device comprising a casing 2, 102 which accommodates the two electrodes, the focusing means and the fractionation device, characterized in that said casing is in communication with the outside through two discharge channels which are substantially arranged symmetrically relative to the fractionation device, on either side of it, said channels extending substantially in the same plane as the fractionation device. This fully symmetrical configuration of the device offers improvements, particularly in terms of compactness.

Although the invention has been described in relation to particular exemplary embodiments, it is clearly not limited to them in any way, and it moreover covers all the technical equivalents of the described means, as well as their combinations, if they fall within the scope of the invention.

### SUSCEPTIBILITY OF INDUSTRIAL APPLICATION

The industrial application of the invention is found in the design, production and use of devices for protection against overvoltages due, in particular, to a lightning strike.

1. A device (1, 101) for protecting an electrical power distribution network against the overvoltages due, in particular, to a lightning strike, the device comprising:
a first electrode (3) electrically connected to the electrical power distribution network;
a second electrode (4) connected to a grounding conductor;
focusing means (5) capable of guiding an electric arc generated between the first electrode and the second electrode toward a fractionation device (6); and
a casing (2, 102) which accommodates the first electrode and the second electrode, the focusing means and the fractionation device, the casing being in communication with the outside through at least one discharge channel (7, 107) designed so as to substantially lower the temperature of the gases generated by the formation of the electric arc, wherein said at least one discharge channel (7) has at least one change of section.

2. The device as claimed in claim 1, wherein said at least one channel (7, 107) extends substantially in the same plane as the fractionation device (6).

3. The protective device (1, 101) as claimed in claim 1, wherein said at least one discharge channel (7) has at least one chicane (20, 120).

4. The protective device (1, 101) as claimed in claim 3, wherein said at least one chicane (20, 120) forms an angle of between 45° and 180°.

5. The protective device (1, 101) as claimed in claim 1, wherein the fractionation device (6) is arranged between the focusing means (5) and the inlet of the discharge channel (7).

6. The protective device (1, 101) as claimed in claim 1, wherein the fractionation device (6) is formed with the aid of a set of parallel metal plates (14).

7. The protective device (1) as claimed in claim 6, wherein the metal plates (14) are kept at a distance from one another with the aid of two blades (15) having orifices engaged in lateral lugs (16) located on each of the metal plates.

8. The protective device (1) as claimed in claim 1, wherein the focusing means (5) define an arc guiding space substantially having an overall shape which diverges in the direction of the fractionation device.

9. The device as claimed in claim 8, wherein the discharge channel (107), comprises at least a first and second section (119, 123) which are substantially parallel and have substantially equal or at least similar lengths, said sections being in communication through a cavity (121).

10. The protective device (1, 101) as claimed in claim 9, wherein the discharge channel (107) extends laterally relative to the fractionation device.

11. A device (1, 101) for protecting an electrical power distribution network against the overvoltages due, in particular, to a lightning strike, the device comprising:
a first electrode (3) electrically connected to the electrical power distribution network;
a second electrode (4) connected to a grounding conductor;
focusing means (5) capable of guiding an electric arc generated between the first electrode and the second electrode toward a fractionation device (6); and
a casing (2, 102) which accommodates the first electrode and the second electrode, the focusing means and the fractionation device, wherein said casing is in communication with the outside through two discharge channels which are substantially arranged symmetrically relative to the fractionation device, on either side of it, said channels extending substantially in the same plane as the fractionation device.
